(19) United States
(12) Patent Application Publication
(10) Pub. No.: US 2025/0116164 A1
(43) Pub. Date: Apr. 10, 2025

(54) DOWNHOLE ROBOT FOR OIL WELLS

(71) Applicant: Saudi Arabian Oil Company, Dhahran (SA)

(72) Inventors: Rami Jabari, Houston, TX (US); Max Deffenbaugh, Fulshear, TX (US); Thomas Hillman, Missouri City, TX (US); Huseyin Rahmi Seren, Houston, TX (US); Jermetris McLin, Katy, TX (US); Robert Adams, Fulshear, TX (US); Hichem Abdelmoula, Houston, TX (US); Abubaker Saeed, Dhahran (SA)

(21) Appl. No.: 18/910,946

(22) Filed: Oct. 9, 2024

Related U.S. Application Data
(60) Provisional application No. 63/589,187, filed on Oct. 10, 2023.

(51) Int. Cl. E21B 23/00; B63G 8/08; B63G 8/22; E21B 23/01; E21B 47/022; E21B 47/08

(52) U.S. Cl. CPC E21B 23/001; B63G 8/08; B63G 8/22; E21B 23/01; E21B 47/022; E21B 47/08

(57) ABSTRACT

In an implementation, a downhole robot for oil wells includes a pressure housing enclosing an internal gas-filled or vacuum-filled volume and at least one propulsion unit coupled to an end of the pressure housing. The downhole robot includes at least one centralization element. At least one sensor measures properties of interest with respect to the downhole robot and for an environment outside of the downhole robot. The downhole robot also includes a buoyancy system, an electrical power supply, an anchoring system, and a power system configured for non-contact operation.

### CROSS-REFERENCE TO RELATED APPLICATIONS

This application claims priority to U.S. Patent Application No. 63/589,187, filed on Oct. 10, 2023, which is incorporated by reference in its entirety.

### BACKGROUND

Hydrocarbon wells are accessed by equipment to convey sensors, obtain and log measurements, perform inspections, monitor downhole conditions, deploy chemical treatments, and for intervention in downhole locations. Current methods for access or conveyance within a hydrocarbon well include coiled tubing, robotic tractors, and surface-tethered tools. These methods are costly, require auxiliary surface equipment that is difficult to mobilize, and require extensive manpower to operate. Current untethered robotic systems are tractor-based and utilize wheels or tracks that provide traction against a wellbore wall and move the robotic systems along the wellbore. The systems often apply significant force against the wellbore wall to maintain said traction, which can result in wear to the wellbore and to components of the robotic systems. The current robotic systems are also inefficient due to energy losses necessary to overcome friction between moving parts, which limits their speed and range. Moreover, the current robotic systems cannot access laterals in wellbores.

### SUMMARY

The present disclosure describes a downhole robot for oil wells.

In an implementation, a downhole robot for oil wells, comprises: a pressure housing enclosing an internal gas-filled or vacuum-filled volume; at least one propulsion unit coupled to an end of the pressure housing; at least one centralization element; at least one sensor to measure properties of interest with respect to the downhole robot and for an environment outside of the downhole robot; a buoyancy system; an electrical power supply; an anchoring system; and a power system configured for non-contact operation.

Some described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, prior approaches utilizing untethered robotic systems rely on tractor-based systems where the robotic system utilizes wheels or tracks to facilitate movement. These systems are inefficient due to the energy losses necessary for the robotic system to move by counteracting friction. The described approach utilizes propeller-based systems to create necessary thrust to enable movement within wellbores, which is more efficient as it reduces energy loss due to a reduced effect of friction in wellbore fluids. Second, the described approach is not tethered to surface equipment as mission-necessary equipment is housed within the untethered downhole robot, eliminating the need for additional surface equipment and associated personnel required for its operation. Third, the described downhole robot can be autonomous or semi-autonomous in its operation, reducing labor necessary to complete missions within oil wells. Fourth, the described downhole robot is configured with a built-in collapsable anchoring mechanism, which permits greater flexibility to anchor the downhole robot in difficult to navigate regions of the wellbore and for more convenient repositioning and removal of the downhole robot when compared to traditional methods or anchoring equipment within oil wells. Fifth, the described downhole robot is configured with a non-contact method of operation, which eliminates a need for opening a pressure vessel or using an external wired connection.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1A is an illustration of a side-view of a downhole robot for oil wells, according to an implementation of the present disclosure.

FIG. 1B is an illustration of rear perspective view of the downhole robot for oil wells of FIG. 1A, according to an implementation of the present disclosure.

FIG. 2 is an illustration of cut-away perspective view of a counter-rotating, co-axial, propeller-based propulsion unit for the downhole robot for oil wells using two interconnected propellers wherein a first propeller drives a second propeller, according to an implementation of the present disclosure.

FIG. 3A is an illustration of a method for controlling pitch and yaw of the downhole robot for oil wells by adjusting propeller blade pitch based on fluid density, according to an implementation of the present disclosure.

FIG. 3B is an illustration of an apparatus for controlling pitch and yaw of the downhole robot for oil wells by adjusting blade pitch of a pitch-adjustable propeller assembly based on measured torque, according to an implementation of the present disclosure.

FIG. 3C is an illustration of a method for controlling pitch and yaw of the downhole robot for oil wells by adjusting rotation speed for a constant-pitch propeller assembly based on fluid density, according to an implementation of the present disclosure.

FIG. 3D is an illustration of an apparatus for controlling pitch and yaw of the downhole robot for oil wells by adjusting rotation speed of the constant-pitch propeller based on measured torque, according to an implementation of the present disclosure.

FIG. 4 is an illustration of a passive mechanical centralization assembly of the downhole robot for oil wells, according to an implementation of the present disclosure.

FIG. 5 is an illustration of an example topworks launching assembly for deploying the downhole robot for oil wells using a double valve configuration, according to an implementation of the present disclosure.

FIG. 6 illustrates vertical buoyancy deployment and horizontal propulsion in a lateral component for the downhole robot for oil wells, according to an implementation of the present disclosure.

FIG. 7A is an illustration of an anchoring system in a fully retracted configuration, according to an implementation of the present disclosure.

FIG. 7B is an illustration of the anchoring system of FIG. 7A in a partially expanded configuration, according to an implementation of the present disclosure.

FIG. 7C is an illustration of the anchoring system of FIG. 7A in a fully expanded configuration, according to an implementation of the present disclosure.

FIG. 8A is a schematic diagram illustrating an example power circuit for permitting a non-contact method of operation of the downhole robot in oil wells, according to an implementation of the present disclosure.

FIG. 8B is an illustration of an example timing diagram of the power circuit of FIG. 8A, according to an implementation of the present disclosure.

FIG. 8C is an illustration of an example reed switch utilized in the example power circuit of FIG. 8A, according to an implementation of the present disclosure.

FIG. 8D is an illustration of an induction-based energy harvesting circuit for power generation, according to an implementation of the present disclosure.

FIG. 9 is a block diagram illustrating an example of a computer-implemented system used to provide computational functionalities associated with described algorithms, methods, functions, processes, flows, and procedures, according to an implementation of the present disclosure.

FIG. 10 illustrates hydrocarbon production operations that include both one or more field operations and one or more computational operations, which exchange information and control exploration for the production of hydrocarbons, according to an implementation of the present disclosure.

Like reference numbers and designations in the various drawings indicate like elements.

### DETAILED DESCRIPTION

The following detailed description describes a downhole robot for oil wells and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Hydrocarbon wells (e.g., producing wells, injection wells, and monitoring wells) are accessed by equipment to convey sensors, obtain and log measurements (e.g., obtain measurements along an interval), perform inspections (e.g., for corrosion or scale buildup), monitor downhole conditions (e.g., such as monitoring inflow along an interval of the well), deploy chemical treatments (e.g., to inhibit corrosion or scale or to increase productivity or recovery), and for intervention (e.g. to remove sand or debris or to perforate casing) in downhole locations, particularly wells that contain one or more laterals (i.e., horizontal intervals). Current methods for access or conveyance within a hydrocarbon well include coiled tubing, robotic tractors, and surface-tethered (e.g., wireline, e-line, slick-line) tools. These methods are costly, require auxiliary surface equipment that is difficult to mobilize, and require extensive manpower to operate.

Current untethered robotic systems are tractor-based and utilize wheels or tracks that provide traction against a wellbore wall and move the robotic systems along the wellbore. These systems often apply significant force against the wellbore wall to maintain said traction, which can result in wear to the wellbore and to components of the robotic systems. The current untethered robotic systems are also inefficient due to energy losses necessary to overcome friction between moving parts, which limits their speed and range.

Further, the current robotic systems cannot access laterals in wellbores. Prior implementations of untethered logging tools are inserted into a wellbore, descend to a target depth, increase buoyancy (e.g., by dropping a weight), and then float back to the surface. However, since this tool relies on buoyancy forces for motion, it is limited to operating in vertical and deviated wells and cannot access laterals, which decreases overall usefulness.

Another prior implementation resulted in a downhole robot with multiple, non-coaxially mounted propellers, which are pivotably coupled to downhole robot body. This has a disadvantage of lower propulsion efficiency, as energy is expended to offset buoyancy of the downhole robot and thrust vectors of the propellers are not aligned with the axis of the downhole robot, but instead are turned to steer the vehicle.

Accordingly, there is a need for downhole robot for oil wells that is not tethered to the surface, offers fast and efficient propulsion, and can access lateral portions of a wellbore. Described is an autonomous, propeller-driven, neutrally buoyant, logging, downhole robot for oil wells. Specifically, the described approach provides a downhole robot for operation in a wellbore which is: 1) untethered; 2) substantially neutrally buoyant in wellbore fluids; 3) moved by a propeller in contact with the wellbore fluids rather than being moved by wheels or tracks in contact with a wellbore wall; and 4) carries sensors for measuring/logging downhole and vehicle properties. Other variations/description of the described concept can be a submersible vehicle, autonomous downhole robot (ADR), an autonomous downhole vehicle (ADV), or an untethered downhole vehicle (UDV).

Energy efficient motion may be provided by the downhole robot, resulting in low-energy requirements and allowing extended vehicle distance traversal from batteries and motion at higher speeds than is achieved by wheeled or tracked downhole robots. In various implementations, the downhole robot can be semi-autonomous, operate under supervised autonomy, automated, remotely operated, or autonomous.

For the purposes of this disclosure:

“Untethered” means that there is no cable or tubing connecting the downhole robot with the surface. The downhole robot carries necessary energy (e.g., using batteries or other energy storage devices) needed to complete a mission.

“Downhole robot” means a mobility platform or conveyance suitable for carrying sensors or measurement instruments, chemical treatments, or intervention tools into a downhole environment and suitable for operation at high-temperature, -pressure, and -corrosive environments of oil or gas wells.

“Substantially neutrally buoyant” means that effective density of the downhole robot, meaning the mass of the downhole robot divided by its volume, is substantially equal to the average density of downhole fluids around the downhole robot.

“Substantially equal” means that effective density of the downhole robot is within +/−20% of an average density of the downhole fluids around the downhole robot. “Substantially equal” can also mean that frictional force from maintaining downhole robot centralization in the wellbore (i.e., a force that depends on a buoyancy mismatch between the downhole robot and the wellbore fluids) is no more than a drag force on the downhole robot that must be overcome for forward motion.

“Moved by a propeller” means that thrust to accomplish motion along an axis of the downhole robot is provided by a propeller that acts on the fluids in the wellbore rather than by wheels or tracks that act on the wellbore wall.

“Carries sensors” means that the downhole robot carries sensors to measure properties of interest outside the downhole robot as well as sensors to determine properties of the downhole robot. In some implementations, sensors for outside the vehicle may include but are not limited to temperature, pressure, fluid flow rate, fluid composition (including chemical composition and/or phase composition, such as water fraction or gas volume fraction), fluid density, fluid viscosity, pipe or wellbore diameter or geometry, corrosion, scale, sand deposits, casing collar detectors, acoustic sensors, and vibration sensors. In some implementations, sensors to determine properties of the downhole robot can include accelerometers, gyroscopes, magnetometers, attitude sensors, gravity sensors, as well as sensors used for navigation, such as casing collar locators, metal sensors, magnetometers, acoustic sonars, an imaging system, electromagnetic imaging systems, and inductive measurements of conductive objects.

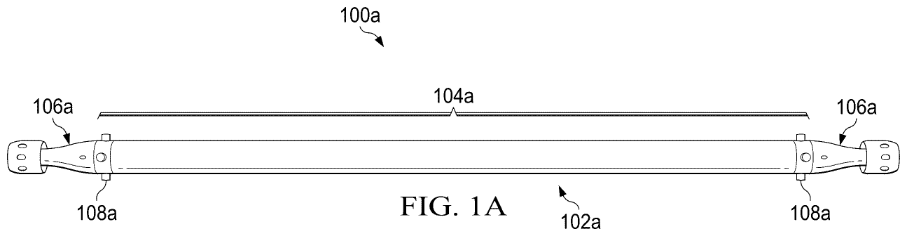

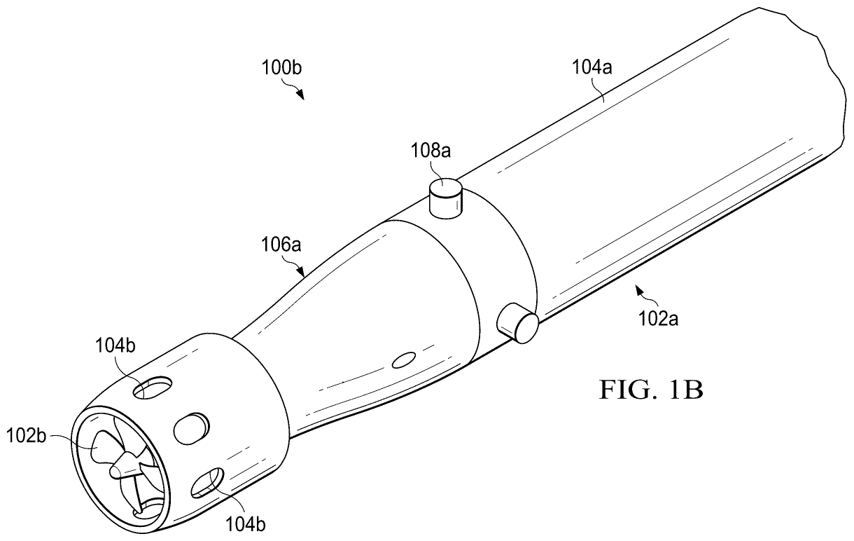

FIG. 1A is an illustration of a side view 100a of a downhole robot for oil wells, according to an implementation of the present disclosure. As shown in FIG. 1A, a downhole robot 102a includes a pressure housing 104a, two propulsion units 106a, and two passive mechanical centralization elements 108a.

In some implementations, pressure housing 104a excludes downhole fluid from an internal gas-filled or vacuum volume. The internal gas-filled or vacuum volume provides buoyancy and optionally contains and protects electronic components and/or batteries that are not able to operate unprotected in the downhole fluids.

In some implementations, the pressure housing 104a is substantially cylindrical, at least in the midsection of the downhole robot 102a. Optionally the pressure housing 104 is tapered at the ends of the downhole robot 102a to facilitate uniform flow of the fluid displaced by the downhole robot 102a through the annulus between the downhole robot 102a and the wellbore as the downhole robot 102a moves. In an implementation, the diameter of the downhole robot 102a at its midsection is a substantial fraction (25% to 80%) of the smallest diameter in the wellbore, which may be an inner diameter of production tubing, a casing diameter in the case of a cased completion with no tubing, or a diameter of the borehole in the case of a barefoot (uncased) completion.

In one implementation, a length of the downhole robot 102a is at least 2× a diameter of the wellbore. This combination of radius and diameter means the downhole robot 102a does not need to steer, but rather its direction is guided by the wellbore.

In one implementation, the axis of a propulsion unit 106a is the same as an axis of the downhole robot 102a. In this implementation, the propulsion unit 106a generates thrust along the axis of the downhole robot 102a. FIG. 1A illustrates the downhole robot 102a with propulsion units 106a on each axial end of the pressure housing 104a.

FIG. 1B is an illustration of rear perspective view 100b of the downhole robot for oil wells of FIG. 1A, according to an implementation of the present disclosure.

As illustrated in FIG. 1B, the propulsion unit 106a includes a propeller 102b and ducts 104b.

### Roll Control/Propeller Torque Compensation

When a submersible vehicle (e.g., the downhole robot 102a) operates in a liquid or fluid mixture and is driven by a propulsion unit (e.g., e.g., propulsion unit 106a with propeller 102b of FIG. 1B) rotating in line with the submersible vehicle's axis, the propeller generates thrust along the axis of the submersible vehicle, but also generates a torque around the axis of the submersible vehicle. If the generated torque is unbalanced and uncompensated for, it can cause undesirable roll (i.e., bias the submersible vehicle to rotate around its axis).

In an implementation, the torque can be compensated for by distributing the mass of the submersible vehicle such that the center of mass is below the axis of the submersible vehicle For example, batteries and heavy motor components can be positioned (not illustrated) such that they are off axis of the submersible vehicle's axis (e.g., downhole robot 102a when oriented horizontally). This configuration produces a vertical separation between a center of mass and a center of buoyancy of the submersible vehicle, which introduces a righting moment that works to offset propeller-produced torque.

In another implementation, the torque can be compensated for by using counter-rotating propellers. The counter-rotating propellers can be situated co-axially on the submersible vehicle.

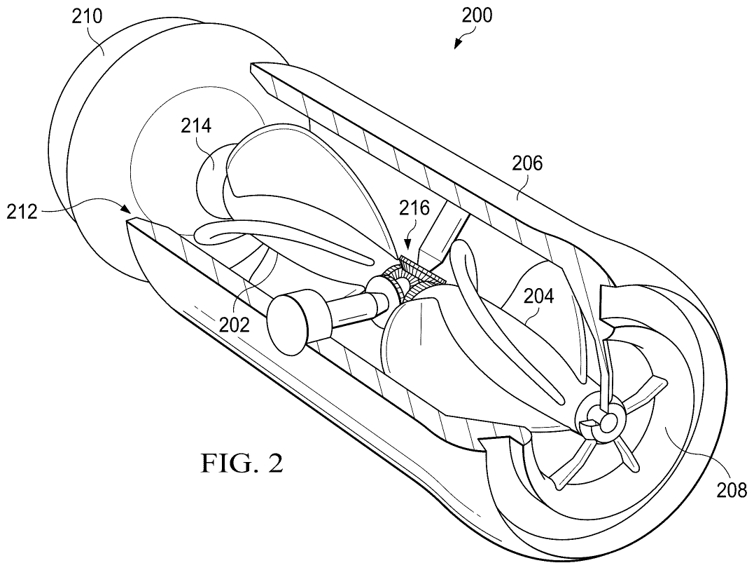

FIG. 2 is an illustration of cut-away perspective view of a counter-rotating, co-axial, propeller-based propulsion unit 200 for the downhole robot for oil wells using two interconnected propellers wherein a first propeller drives a second propeller, according to an implementation of the present disclosure.

In an implementation, the downhole robot 102a has an even number (preferably 2) of counter-rotating co-axial propellers 202 and 204 such that torque generated by each of the two co-axial propellers around the axis of the downhole robot 102a is substantially cancelled, preventing a net torque around the axis of the downhole robot 102a which could otherwise cause the downhole robot 102a to roll.

In an implementation, the two counter-rotating co-axial propellers 202 and 204 are integrated into a streamlined shell 206. In some implementations, the streamlined shell 206 includes an intake vent/axis support 208 and coupler 210 to attach the propulsion unit 200 to the ends of the downhole robot 102a. In some implementations, the streamlined shell 206 defines an outlet 212 between the streamlined shell 206 and the coupler 210 to permit fluid to vent/flow past the counter-rotating co-axial propellers 202 and 204 and around the coupler 210.

In an implementation, there is a direct drive of the two counter-rotating co-axial propellers 202 and 204 are configured with a direct drive, with one propeller driving the other. Propellers in this configuration exhibit synchronized, yet opposing, rotation and are configured with opposite pitch on the propeller blades, such that opposing rotation generates thrust in a common direction. In the illustrated implementation, a primary propeller 202 is set in motion by a rotating shaft 214, while the secondary propeller 204 derives its power from the interplay of gear teeth 216 located on the interfacing ends of the two counter-rotating co-axial propellers 202 and 204. Rotation of one propeller is transmitted to the other propeller but reversed in direction. This design works to reduce fluid swirl on the outlet 212 of the propulsion unit 200, reducing energy lost to turbulence.

In an implementation, the two counter-rotating co-axial propellers 202 and 204 integrated into the streamlined shell 206 and are placed on opposite ends of the downhole robot 102a (i.e., each end of the pressure housing 104a) and centered on the axis of the downhole robot 102a (i.e., axially positioned propellers). In this implementation, thrust is applied at both ends, making both forward and reverse motion stable with respect to roll control/propeller torque. In an implementation, the two counter-rotating co-axial propellers 202 and 204 can be operated at different speeds to produce a torque imbalance to purposely adjust the roll of the vehicle.

### Pitch/Yaw Control in Stratified Fluids

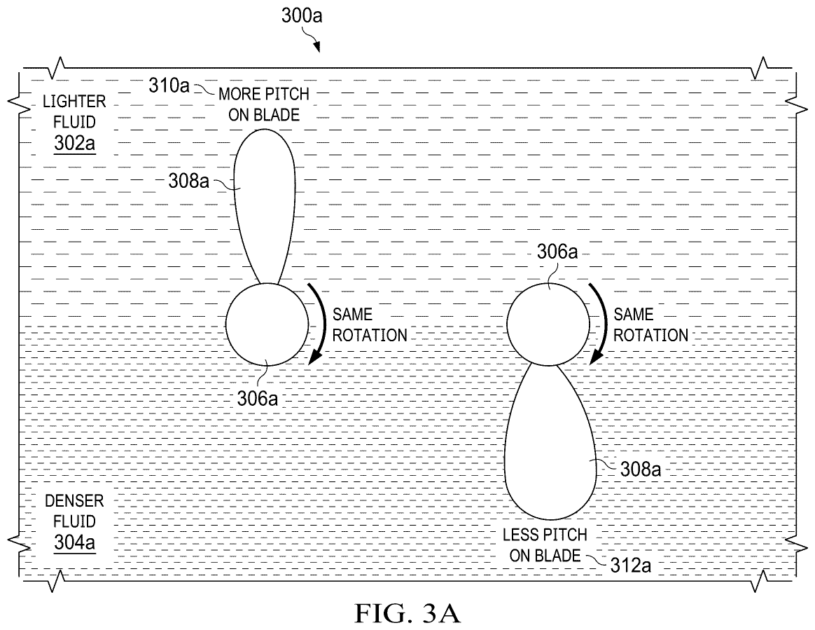

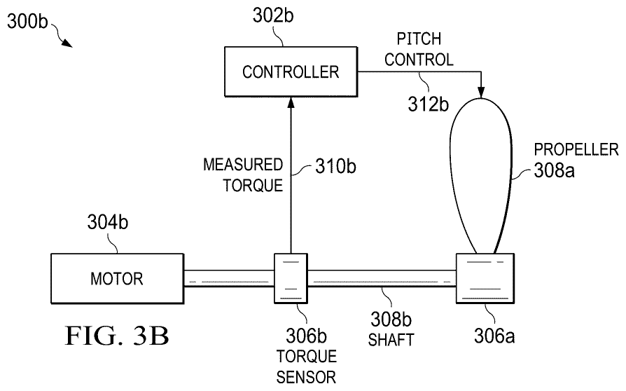

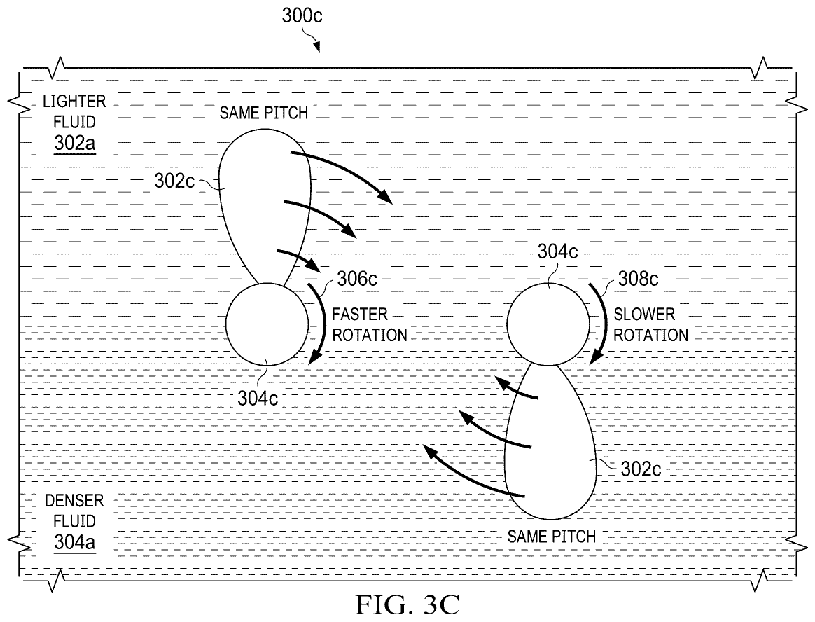

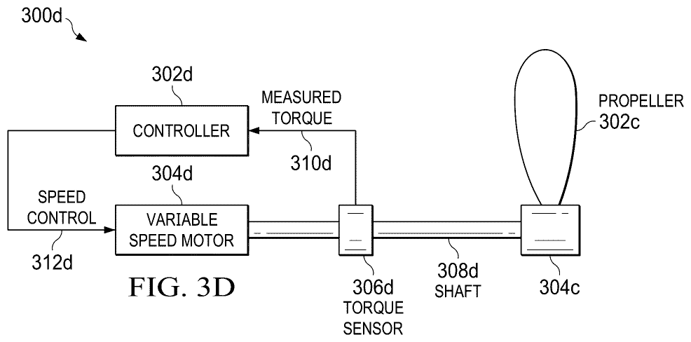

FIG. 3A is an illustration of a method 300a for controlling pitch and yaw of the downhole robot for oil wells by adjusting blade pitch of a pitch-adjustable propeller assembly based on fluid density, according to an implementation of the present disclosure. At high-level, in method 300a, pitch of at least one propeller blade is increased when the propeller blade is within a lighter fluid and pitch is decreased when the propeller blade is within a denser fluid.

Oil wells typically produce a mixture of oil, brine, and natural gas, where the natural gas is typically in a liquid or supercritical state at downhole pressures. These fluids have different densities, and in a lateral, these fluids may form a stratified mixture which is lighter 302a at the top of the horizontal borehole and denser 304a at the bottom of the horizontal borehole.

In a mixture with stratified density, a propeller 306a rotating at a constant rate would produce more thrust when passing through the lower, denser fluid 304a than through the higher, lighter fluid 302a. In a lateral, where the axis of a downhole robot 102a is substantially horizontal and the fluid density varies perpendicularly in relation to the axis of the downhole robot 102a, this would result in a net thrust of a rotating propeller 306a with an upward pointing direction relative to the axis of the downhole robot 102a. The vertical component of the thrust vector would be wasted energy and would tend to direct the downhole robot 102a upward against the upper side of the wellbore.

In an implementation, the propeller 306a has at least one pitch-adjustable blade 308a that is adjustable in pitch angle and a controller which can adjusts the pitch angle of the pitch-adjustable blade 308a to achieve a desired amount of thrust from the propeller 306a. As the propeller 306a rotates, its instantaneous thrust depends on a produced instantaneous mass flow rate (e.g., kg/s). To produce an average thrust in a direction of the axis of the downhole robot 102a (assumed to be the same as an axis of the propeller shaft), the mass flow rate should be identical regardless of an instantaneous rotation angle of the propeller 306a.

In the previously described density-stratified fluid, keeping the instantaneous mass flow rate past the propeller blade identical regardless of fluid density requires having more pitch 310a (larger angle of attack) in the lighter fluid 302a to increase the volumetric flow rate (m\hat{ }3/s) and having less pitch 312a (smaller angle of attack) in the denser fluid 304a to decrease the volumetric flow rate. In an implementation, the pitch of at least one blade of propeller 306a is adjusted based on at least the density of the surrounding fluid to maintain a substantially equal forward thrust for all angles of rotation of the propeller.

Turning to FIG. 3B, FIG. 3B is an illustration of an apparatus 300b for controlling pitch and yaw of the downhole robot for oil wells by adjusting propeller blade pitch based on measured torque, according to an implementation of the present disclosure. At a high-level, in apparatus 300b, a measured torque value is used to adjust a pitch angle of at least one propeller blade.

In an implementation, a controller 302b measures torque of propeller 306a rotated by motor 304b using a torque sensor 306b coupled to a propeller shaft 308b. The controller 302b adjusts the pitch angle of at least one pitch-adjustable blade 308a. A measured torque value 310b is used by the controller 304b to generate a pitch control 312b value which is used to adjust the pitch-adjustable blade 308a of propeller 306a. In this way, a same propeller shaft torque is maintained for all angles of propeller 302a rotation.

In an implementation, the controller 302b subtracts from the measured torque 310b a contribution due to the varying viscosity of the wellbore fluids. This compensation may be accomplished by directly measuring fluid viscosity at the propeller 306a or by using a previously measured or theoretically determined relationship between density and viscosity of a mixture or emulsion of wellbore fluid.

In an implementation, propeller blades (e.g., pitch-adjustable blade 308a) of propeller 306a are in an asymmetric arrangement around a hub of propeller 306a or are symmetrically oriented around the hub of propeller 306a, but with an odd number of blades (e.g., one blade or three blades). In an implementation, the rotation rate of a propeller with an odd number of pitch-adjustable blades 308a is varied over the course of each rotation to create a thrust vector that is offset from the axis of the vehicle to steer the vehicle or adjust the pitch or yaw of the vehicle.

FIG. 3C is an illustration of a method 300c for controlling pitch and yaw of the downhole robot for oil wells by adjusting rotation speed for a constant-pitch propeller assembly based on fluid density, according to an implementation of the present disclosure. At a high-level, a propeller speed or rotation rate can be adjusted based on a density profile of a stratified fluid to generate a net thrust vector along the axis of the downhole robot 102a instead of a net thrust vector which is offset relative to the axis of the downhole robot 102a.

In an implementation, to produce an average thrust in a direction of the axis of the downhole robot 102a (assumed to be the same as the axis of a propeller shaft), a mass flow rate should be identical regardless of an instantaneous rotation angle of a propeller. In a density stratified fluid (e.g., as described in FIG. 3A), keeping an instantaneous mass flow rate (e.g., kg/s) identical past a constant-pitch blade 302c of a propeller 304c, regardless of the fluid density, requires moving the constant-pitch propeller faster 306c (larger rotation rate) in the lighter fluid 302a to increase the volumetric flow rate (m\hat{ }3/s) and rotating the constant-pitch propeller slower 308c (slower rotation rate) in the denser fluid 304a to decrease the volumetric flow rate (m\hat{ }3/s).

FIG. 3D is an illustration of an apparatus 300d for controlling pitch and yaw of the downhole robot for oil wells by adjusting rotation speed of the constant-pitch propeller based on measured torque, according to an implementation of the present disclosure.

In one implementation, a controller 302d measures the torque of propeller 304c rotated by variable speed motor 304d using a torque sensor 306d coupled to a propeller shaft 308d. A measured torque value 310d from the torque sensor 306d is used by the controller 302d to adjust a rotation rate with a speed control 312d value to the variable speed motor 304d throughout each cycle of rotation to maintain a constant torque. In this way it adjusts the rotation rate of the constant-pitch propeller 304c to maintain a substantially equal thrust regardless of the density of the fluid around the propeller blade 302c.

In one implementation, the controller 302d subtracts from the measured torque 310d a contribution to overcome a viscosity of the wellbore fluids. This compensation may be accomplished by directly measuring the fluid viscosity at the propeller 304c or by using a previously measured or theoretically determined relationship between density and viscosity of a mixture or emulsion of wellbore fluids.

### Centralization

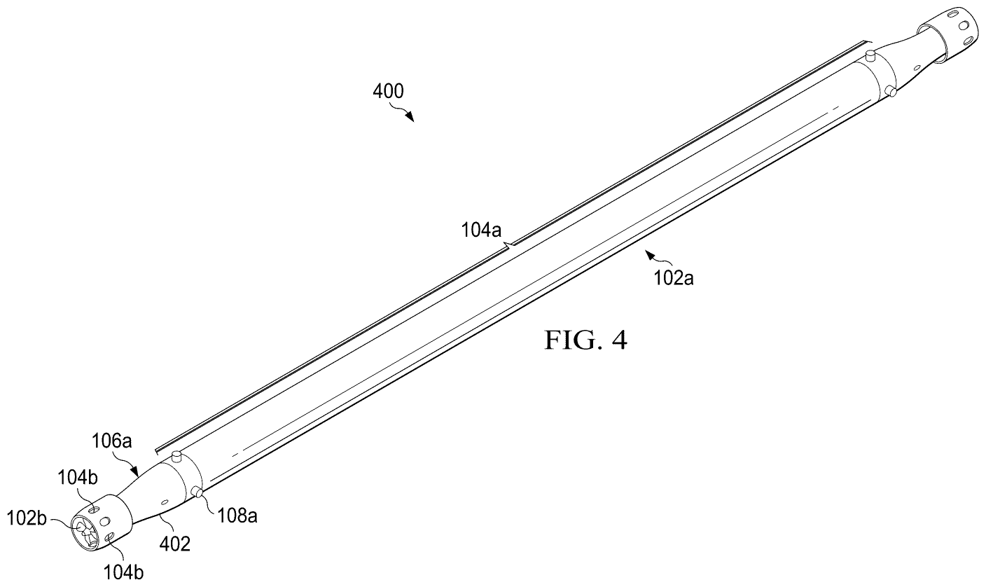

FIG. 4 is an illustration of a passive mechanical centralization assembly 400 of the downhole robot for oil wells, according to an implementation of the present disclosure.

To minimize energy required for propulsion of the downhole robot 102a, the downhole robot 102a needs to be maintained in a centered position in the wellbore or tubing, in which the downhole robot 102a transverses. By centered, it is meant that the center axis of the downhole robot 102a is substantially the same as the center axis of the surrounding wellbore or tubing.

In an implementation, the downhole robot 102a can be configured with one or more passive mechanical centralization elements 108a (or centralizer, e.g., a spring, wire, skid, or post/nub that can be used to maintain a fixed offset from the wellbore interior). A passive mechanical centralization element 108a is preferentially located near each end of the downhole robot 102a, such that they exert maximum torque around the center of mass of the vehicle for a given force on the centralizers 108a. Minimizing force on the centralizers 108a is important, as that force produces frictional energy loss against the wellbore or tubing around the downhole robot 102a.

In an implementation, propeller wash (outflow from a propeller) is directed in equal distribution around the circumference of the downhole robot 102a, for example by having the propeller 102b mounted at a tapered end of the vehicle (e.g., at taper 402) where the taper 402 is symmetric around the axis of the vehicle.

In an implementation, the downhole robot 102a can be configured with an active internal mechanical/computing system that enables centralization of the downhole robot 102a within the wellbore or tubing round the downhole robot 102a. Examples of an active internal mechanical/computing system can include an active pump to change ballast and trim while traversing the wellbore and a computing system to monitor data from sensors such as an accelerometer or gyroscope.

In an implementation, the downhole robot 102a can be configured with control surfaces (such as fins, wings, other lifting surfaces, and/or drag inducing systems) such that the control surfaces are used to generate forces from the flow that serve to maintain centralization by active control. In some implementations, an active controller receives input from a sensor, which determines how far the downhole robot 102a vehicle is off-center within a wellbore or tube. In some implementations, the sensor can measure, for example, a distance of the downhole robot 102a from the interior of the wellbore or tubing in at least two points around the circumference of the downhole robot. One example could include a sonar type sensor that could emit and receive returned sound or light waves to calculate a distance from the downhole robot 102a to the interior of the wellbore or tubing.

### Deployment Method

As previously mentioned, current methods for access or conveyance within a hydrocarbon well include coiled tubing, robotic tractors, and surface-tethered (e.g., wireline, c-line, slick-line) tools. These methods are costly, require auxiliary surface equipment that is difficult to mobilize, and require extensive manpower to operate. The downhole robot 102a for oil wells can be deployed untethered into an oil well to perform downhole measurement and logging applications and does not require extensive surface equipment, extensive crews, or extensive downtime.

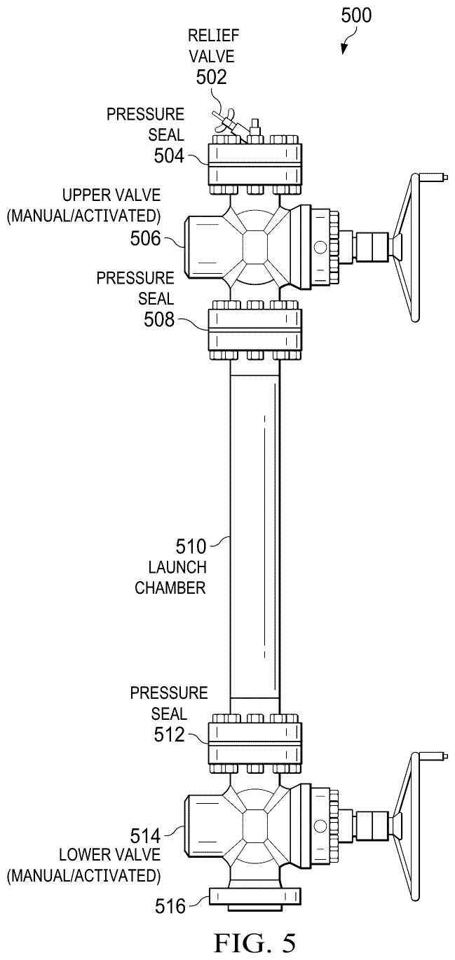

FIG. 5 is an illustration of an example topworks launching assembly 500 for deploying the downhole robot for oil wells using a double valve configuration, according to an implementation of the present disclosure. At a high-level, the topworks launching assembly 500 is a wellhead tree modification, which may be added to an oil well to enable simple deployment of an untethered downhole robot 102a, while maintaining a pressure barrier of protection between well contents and the environment.

In an implementation, the illustrated topworks launching assembly 500 includes (from top to bottom) a relief value 502, pressure seal 504, upper valve (manual/actuated) 506 (or upper value 506), pressure seal 508, launch chamber 510, pressure seal 512, and lower valve (manual/actuated) 514 (or lower valve 514). The topworks launching assembly 500 launch changer 510 is a section of pipe approximately the same bore diameter as vertical clearance through the wellhead tree. The launch chamber 510 is at least as long as the downhole robot 102a, such that the vehicle can fit between the ends of the launch chamber 510. In some implementations, there is a mounting flange or connector 516 at the lower end of the launch chamber 510 such that the wellhead tree cap (or optionally the wellhead tree cap assembly, including both the cap and the fitting which the cap screws onto, may be removed and the topworks launching assembly 500 attached to the top of the oil well. In some implementations, the upper valve 506 and associated components are optional (i.e., the pressure seal 504 and upper value 506 can be removed leaving the relief value 502, pressure seal 508, and remaining components as previously described).

The relief value 502 is a gas bleed valve or gas vent valve at the top of the topworks launching assembly 500 and a lift point (not illustrated). The lower valve 514 at the bottom of the topworks launching assembly 500 just above the mounting flange or connector 516.

In the described implementation of FIG. 5:
1) The downhole robot 102a is initially placed into the topworks launching assembly 500 through the lower valve 514 (lower gate valve) and then the lower valve 514 is closed. If the topworks launching assembly 500 is comprised of both a lower value 514 and upper valve 506 (upper gate valve), the vehicle may enter through either lower valve 514/upper valve 506 or both lower valve 514/upper value 506 must be closed when the downhole robot 102a is inside.
2) On an existing wellhead tree (not illustrated), the tree master valve or preferably the lower master valve and upper master valves should be closed.
3) Close a wing valve (not illustrated) of the existing wellhead tree.
4) If the existing wellhead tree does have both a lower master valve and upper master valve, ensure the existing wellhead tree crown valve(s) (not illustrated) are opened. Otherwise, the existing wellhead tree crown valve(s) must be in the closed position.
5) Vent or capture any excess gas through a gas bleed valve (not illustrated) on the existing wellhead tree cap to relieve trapped pressure.
6) Break connections and remove the existing wellhead tree cap or existing wellhead tree cap assembly from the top of the existing wellhead tree.
7) The topworks launching assembly 500 (with downhole robot 102a inside) is lifted above the existing well head tree by the lift point typically using a crane.
8) A new gasket is added and connection to the oil well is secured on a master value (not illustrated) of the oil well where the existing wellhead tree cap assembly was removed.
9) Pressure test connection on the topworks launching assembly 500 for possible leaks.
10) If closed, open upper valve 506.
11) Open lower valve 514 of topworks launching assembly 500 allowing the downhole robot 102a to descend until it is against the master valve of the oil well.
12) Next, the topworks launching assembly 500 upper valve 506 and lower valve 514 are closed (to maintain two pressure barriers).
13) The master valve is then opened allowing the downhole robot 102a to descend into the oil well. During a downhole robot 102a mission, a wing valve (not illustrated) can optionally be opened if it is desired to flow the well.

To recover the downhole robot 102a, a similar process is followed to return the downhole robot 102a to its initial position within the topworks launching assembly 500:
1) When the downhole robot 102a mission is complete, the well is flowed to return the downhole robot 102a into the topworks launching assembly 500. The force of flow will tend to lift the body of the downhole robot 102a above the wing valve. Once the downhole robot 102a is so lifted, the master valve is closed trapping the downhole robot 102a within the topworks launching assembly 500.
2) The wing valve is also closed.
3) Gas may be vented through the relief valve 502 at the top of the topworks launching assembly 500.
4) Water or oil may be injected through the relief valve 502 and any remaining gas vented until the topworks launching assembly 500 is full of liquid. At that point, the downhole vehicle 102a (being lighter than the liquid) will float into the topworks launching assembly 500.
5) Once the downhole robot 102a is in the topworks launching assembly 500, the lower value 514 of the topworks launching assembly 500 is closed, trapping the downhole robot 102a within the topworks launching assembly 500.
6) Other valves of the wellhead are closed, the topworks launching assembly 500 with the downhole robot 102a inside is removed, and the original (existing) wellhead tree cap/cap assembly is replaced onto the original (existing) wellhead tree.

In some implementations, valves can be actuated manually, pneumatically, electrically, or using any combination of the actuation methods. In some implementations, size of pipe/enclosure between valves in the topworks launching assembly 500 can vary based on the configuration of the downhole robot 102 inside. Fluid can be added in the oil well to dampen impact forces on the downhole robot 102a during deployment.

### Mission Control/Method of Logging

The untethered downhole robot 102a can be utilized for downhole logging. Although removing the tether greatly reduces the overall cost of operations and removed unnecessary delay, at least two challenges remain:
1.) The tether is no longer available to supply power to the vehicle. Therefore, the downhole robot 102a is required to carry enough energy within internal energy storage devices (e.g., a battery bank) to execute the mission (or optionally it must be capable of generating any additional energy required to complete the mission while downhole).
2.) The tether is no longer available to provide communication with the downhole robot 102a.

Many types of logging measurements require synchronization of actions at the surface with downhole actions by the logging tool (e.g., some measurements of flow, inflow, or bottom hole pressure must be taken after the well has flowed for a certain period of time to ensure a stabilized flow condition. A downhole robot 102a may have difficulty moving down the oil well with a propeller-based propulsion unit and/or holding position if the oil well is flowing. In this case, there needs to be synchronization of when the downhole robot 102a clamps in place and measures flow and when the downhole robot 102a is to move to a new measurement location.

Mission programming of an untethered downhole robot 102a (e.g., propeller or track driven) can be performed by, for example:
(1) Preprogramming mission operations based on time for coordination with an operator at the surface.
   Moving between flowing the well.
      Can also be triggered by flow.
(2) Reconfigure mission by communicating with downhole robot 102a by changing flow at surface.
   Pattern of flow rate based on downhole robot 102a expected schedule set at beginning of mission.
      Trigger downhole robot 102a to move.
      Switch zones, return to surface, go further towards toe.
      Flow pulse duration and time between flow pulses can have different meanings.
(3) Hold in place for a period of time, then moves on and holds in place again.
   Station keeping with propulsion system.
   Can be during or without flow.
      During flow.
         Production logging requires flow.
         In flow measurements.
         Water injection in flow.
         Tracer reading.
      Without flow.
         Mapping location of perforations.
         Acoustic listening of flow behind casing for channeling in cement.
         Mounds of sand production or proppant buildup.
         Mapping well deviations/porpoising in wellbore geometry.
         Pressure variation.
         Fluid density.
         Scale build-up.
         Debris build-up.
         Casing dimension measurements.
         Well, inspection.
(4) Preprogram mission when well is flowing and not flowing.
(5) Preprogrammed time schedule for recording in motion.
(6) Trigger to propulsion based on inclinometer, distance traversed, velocity, gravity measurement, accelerometer measurements, gyroscopes, and/or mercury switch.

Before the downhole robot 102a is deployed into the oil well, a mission is described in terms of:
(1) Fixed times when certain actions will be performed (e.g., 3:00 am on January 4).
(2) Relative times when certain actions will be performed (e.g., 1 hour 15 minutes after the last action).
(3) Decision times when the downhole robot 102a will measure the flow rate around it for a period of time and based on that measurement select a course of action from a set of pre-defined alternatives.
   Buoyancy Driven to Propeller Driven Downhole Robot for Oil Wells with a Lateral Component

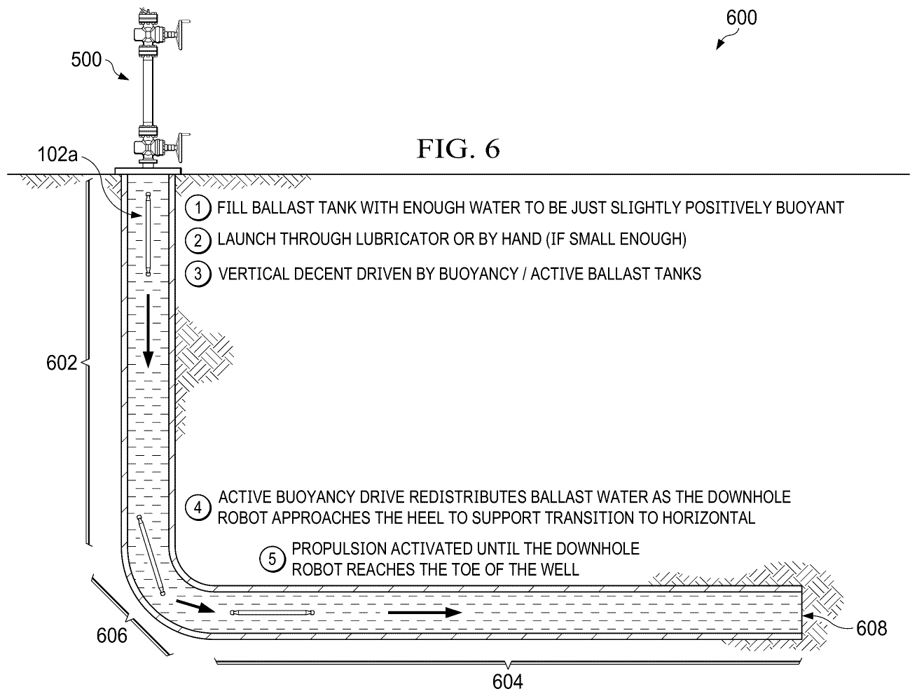

FIG. 6 illustrates vertical buoyancy deployment and horizontal propulsion in a lateral component of a well for the downhole robot for oil wells, according to an implementation of the present disclosure.

It has been established that a propeller driven downhole robot 102a can be utilized for downhole logging. It is critical to ensure that minimal power is consumed in both a vertical component 602 and a lateral component 604 of an oil well. In the illustration, the downhole robot 102a utilizes buoyancy for a vertical descent in the lateral component 602 towards a well heel 606 and propulsion for horizontal movement in the lateral component 604 while moving towards the oil well toe 608. A combination of a buoyancy-type drive for the vertical component 602 and well heel 606 traversal, along with one or more propellers coaxially mounted to a streamlined hull for lateral/horizontal well sections (e.g., as described in FIGS. 1A, 1B, and 2) minimizes energy consumption for well traversal when the downhole robot 102a is negatively buoyant in the vertical component 602 and neutrally buoyant in the lateral component 604.

A method is provided to allow a downhole robot 102a capable of changing modes of propulsion while in an oil well, based on a well component the downhole robot 102a is in.

At (1), a ballast tank of the downhole robot 102a is filled with just enough water to be slightly positively buoyant.

At (2), the downhole robot 102a is launched through a lubricator of the topworks launching assembly 500 or by hand if small enough.

At (3), in a vertical descent through the vertical component 602a, the downhole robot 102a is driven by buoyancy/active ballast tanks. The downhole robot 102a is negatively buoyant, which can be achieved by detachable weights, buoyancy/active ballast tanks (e.g., a bladder filled with liquid), or electrolysis.

At (4), as the downhole robot 102a approaches the heel 606 of the oil well, an active buoyancy drive redistributes ballast water, detachable weights, etc. to support transition to horizontal and near neutrally buoyancy.

At (5), once through the heel 606 of the oil well, the downhole robot is near neutrally buoyant (e.g., within + or −20%). Propulsion (e.g., the counter-rotating, co-axial, propeller-based propulsion unit 200 of FIG. 2) is activated to propel the downhole robot 102a until the downhole robot 102a reaches the toe of the well 608.

Upon reaching the toe, the propulsion drive enables the downhole robot 102a to return towards the heel 606. Optionally, the downhole robot 102a can release any attachment to the wellbore or tubing around it and allow itself to be flowed back by turning on or increasing production from the oil well). Upon reaching the heel 606, the downhole robot 102a can transition to becoming more buoyant by releasing more weight, pushing liquid out of the buoyancy/active ballast tanks or using electrolysis that generates more gas in the pressure housing 104a, enabling the positively buoyant downhole robot 102a to ascend in the vertical component 602 of the oil well. If the downhole robot 102a is near neutrally buoyant, it can also be returned to the surface by flowing the well. In some implementations, the buoyancy drive can be unidirectional (e.g., the downhole robot 102a can only become less negatively buoyant) or bidirectional (e.g., the downhole robot 102a can become less negatively buoyant or more negatively buoyant).

In some implementations, the downhole robot 102a can have an internal navigation system for determining depth/distance traversed, along with downhole robot 102a pose/attitude in the oil well so the downhole robot 102a can appropriately adjust buoyancy and know when to turn propellers on/off. In some implementations, this can be achieved by utilizing magnetometers for casing collar location, inertial measurement units (IMUs)/accelerometers, or optical flow sensing, to determine position in the oil well based on a direct reading or integration of acceleration or velocity measurements. Attitude can be obtained using gyroscopes and IMUs/accelerometers, an inclinometer, or an attitude and heading reference system (AHRS) and enable the downhole robot 102a to determine when it is in the heel 606. If centralizers 108a are used, strain can be measured through the centralizer 108a, allowing the downhole robot 102a to determine if it is rubbing on the wellbore wall and to make a decision regarding changing buoyancy.

### Collapsible Anchor

The drilling and exploration of wellbores, whether for oil and gas extraction, geothermal energy production, or various other subsurface applications, have long been critical processes in the energy industry. These endeavors often require the positioning and secure anchoring of tools and downhole devices within the wellbore or deployed piping.

It has been established that a downhole robot 102a may be used to traverse in an oil well through the vertical component 602 and lateral component 604, including the heel 606. Additionally, there may be a need to anchor the downhole robot 102a in place then move again based on a zone of the oil well the downhole robot 102a is in.

Often, anchoring systems serve a purpose of sealing off an annular portion of the wellbore between the production tube and the oil well casing from a producing portion of the wellbore, these types of anchoring systems are called packers. Packers are traditionally both run and set on a production tubing string. There are two classifications for packers, permanent and retrievable.

Permanent packers can, in most applications, only be removed from the wellbore by milling. Mechanical packers, while widely used, require specialized tools and equipment for installation. They are typically set at predetermined depths and cannot be repositioned once deployed. This lack of flexibility limits adaptability during dynamic well operations. Some versions of these packers can be removed, but this requires removal of the production string.

Retrievable packers can be removed or moved without destroying the packer. There are various methods to set and retrieve retrievable packers, but each method requires specialized methods and equipment. The retrievable packer may or may not be resettable, but removal from the wellbore normally does not require milling. Retrieval is usually accomplished by some form of tubing manipulation. This may necessitate rotation or require pulling tension on the production string.

Aside from packers, another function of a downhole anchor is to isolate sections of a well. This can reduce a total pumping pressure in long casing strings, prevent lost circulation by reducing total hydrostatic pressure on weak zones, and/or enable a gas-tight seal against the formation. This is usually accomplished with stage cementing or sliding sleeve systems.

Stage Cementing is a cementing process that involves injecting cementitious or resinous materials at a specific location or locations within a wellbore to isolate targeted sections of the well. The cement material can only be removed by milling or drilling.

Sliding Sleeve Systems offer some flexibility by enabling selective opening and closing of ports on the sliding sleeves to control fluid flow. Main uses of sliding sleeve systems are to shut off flow from one or more reservoir zones or to regulate pressure between zones. However, sliding sleeve systems often require complex and costly completion processes, making them less practical for certain applications.

Yet another function of a downhole anchor, is one that holds a tool in place within a wellbore (e.g., on a wireline or on an autonomous downhole vehicle). This anchor would be incorporated into the design of such a tool, such that the tool would be able to traverse to a location, “drop anchor,” and become centralized within the wellbore, take measurements or readings, “weigh anchor,” move to a new location within the wellbore, and repeat the process if necessary.

The previously described anchoring and isolating approaches have a number of drawbacks for the downhole robot 102a. For example, the approaches frequently result in reduced wellbore accessibility and limited adaptability to evolving oil well conditions. Moreover, an inability to reposition or to remove anchored tools easily (i.e., particularly in the wellbore upstream of the production tubing) can lead to inefficiencies, extended downtime, and, in some cases, necessitate costly interventions. Therefore, there is a need for a mobile downhole anchoring system which is not necessarily a permanent fixture of the oil well.

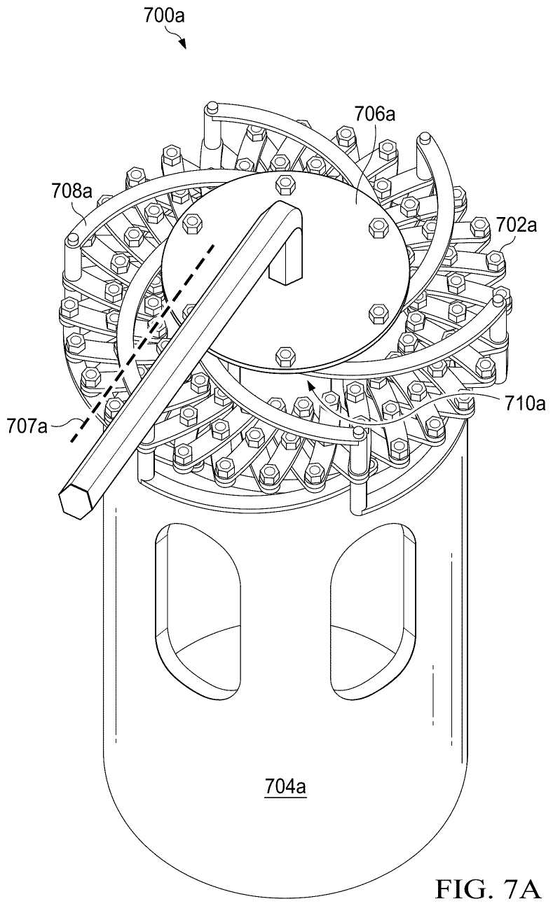

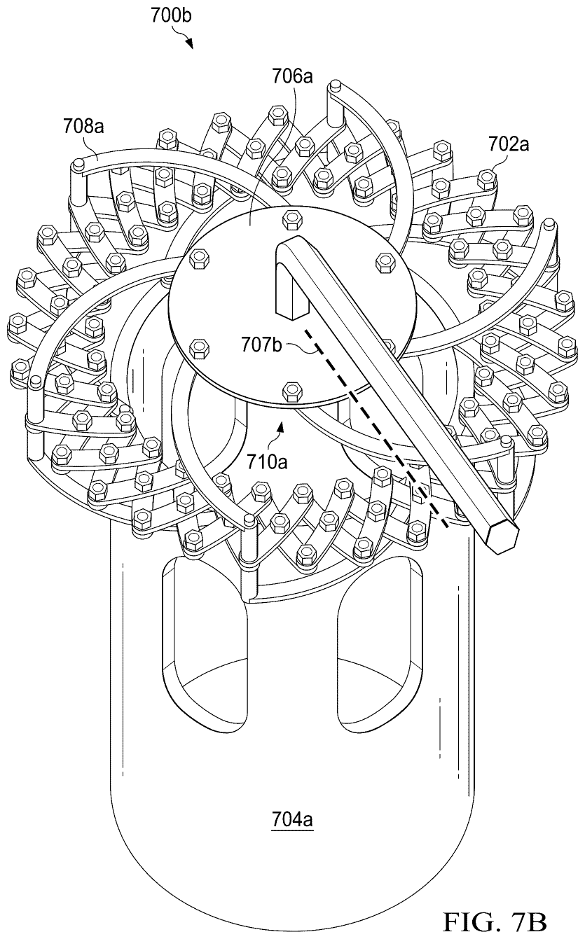

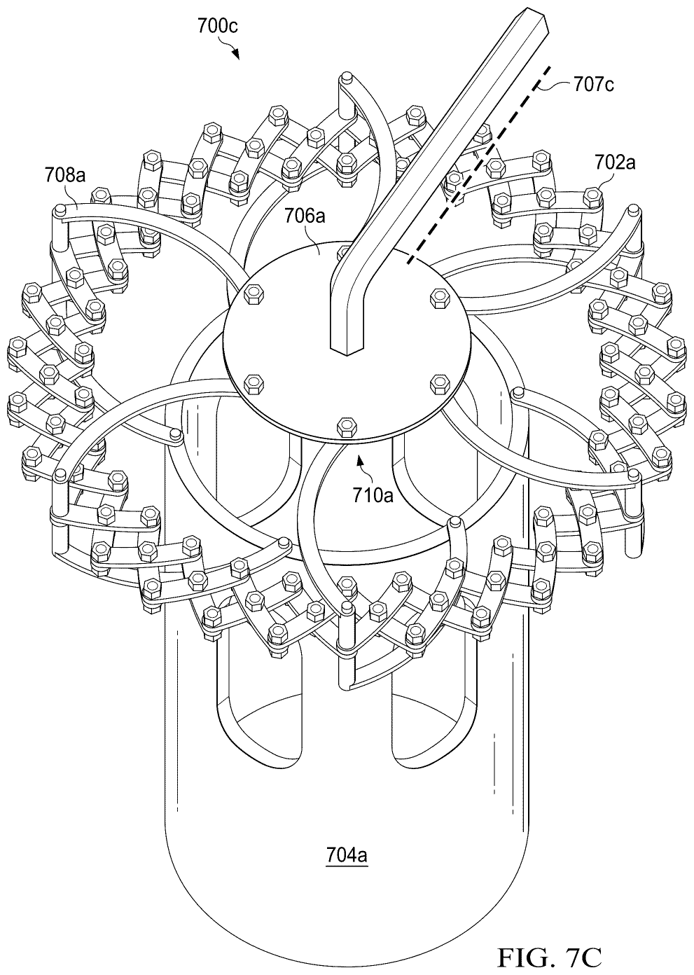

FIG. 7A is an illustration of an anchoring system 700a in a fully retracted (collapsed) configuration, according to an implementation of the present disclosure. The described approach for anchoring tools or other downhole devices within a wellbore or pipe leverages the ingenious Hoberman mechanism (i.e., a collapsible and expandable structure composed of hinged struts or bars (e.g., 702a) in conjunction with a stator 704a, a rotor 706a (at a first position 707a), and, in some implementations, a spring-loaded mechanism (not illustrated). This design permits dynamic positioning and secure anchoring of downhole equipment at any desired location within the wellbore's length, addressing the limitations of the previously described traditional anchoring methods. As illustrated in FIG. 7A, the rotor 706a and rotor arms 708a are at a chosen starting angle 710a.

When integrated into the collapsible anchoring system 700a, the Hoberman mechanism expands or shrinks in response to rotational movement of the rotor 706a. The expansion occurs when the rotor 706a is rotated in one direction, causing the Hoberman mechanism to unfold and extend (i.e., movement of the rotor arms 708a and hinged struts or bars 702a), while rotation in the opposite direction triggers contraction, reducing its size.

The stator 704a serves as a stationary element within the system, providing a fixed point of reference at a defined angle against which the Hoberman mechanism operates. It acts as a guide and support structure for the expanding or contracting motion of the Hoberman mechanism.

The rotor 706a is the central driving element of the described approach. Rotation of the rotor 706a is the primary means by which the Hoberman mechanism is manipulated. When the rotor 706a turns, it imparts a corresponding motion to the Hoberman mechanism, causing it to expand to the inner diameter of the wellbore or pipe (securely anchoring itself in place) or to contract to its collapsed state.

In some implementations, to ensure controlled and reliable anchoring, the Hoberman mechanism may be equipped with a spring-loaded mechanism. This spring exerts a force to keep the Hoberman mechanism in the collapsed state when not in use. This feature aids in efficient deployment and retrieval of downhole equipment.

The rotor 706a may be actuated to counteract the spring force by various means, including mechanical, hydraulic, or electrical mechanisms. This actuation mechanism facilitates the controlled expansion and contraction of the Hoberman mechanism, allowing it to securely anchor itself within the wellbore or pipe when needed or to contract and return to its compact, spring-loaded state, ready for retrieval or repositioning.

In some implementations, the anchoring system 700a may be shrouded in an elastic material (e.g., rubber) to produce a seal against the wellbore or production pipe. This seal, when also coupled to the downhole robot 102a, would prevent flow through the annulus between the downhole robot 102a and the wellbore. If the downhole robot 102a does not permit flow through its own body, then this would effectively shut off flow through the anchor position entirely. The use of this elastic material may also increase friction between the anchoring system 700a and the wellbore or tubing string, reducing the clamping force necessary to maintain position.

In some implementations, potential applications of the described anchoring system 700a include:
1) Downhole Tool Positioning: Securely anchoring tools and downhole devices at specific depths within the wellbore, allowing for precise data collection, sampling, and maintenance operations.
2) Wellbore Construction: Facilitating the installation of casing, liners, or other components by temporarily anchoring them in place during construction.
3) Flow Control: Regulating fluid flow within the wellbore by selectively anchoring and leaving in place.
4) Wellbore Intervention: Enabling efficient and adaptable wellbore interventions, including plug setting, perforation, and well stimulation.
5) Oil and Gas Extraction: Supporting enhanced oil and gas recovery by optimizing wellbore configurations for production and injection operations.

The illustrated anchoring system 700a offers enhanced flexibility, adaptability, and efficiency in a wide array of wellbore and pipe applications. In an implementation, the downhole robot 102a is a substantially neutrally buoyant untethered downhole vehicle which is moved by action of at least one propeller (refer to FIGS. 1A, 1B, and 2). In this case, the anchoring system 700a may be deployed to hold the downhole robot 102a in place in the wellbore and retracted to allow the downhole robot 102a to move in the wellbore. In an implementation the downhole robot 102a comprises a sensor to measure fluid flow, travels to a location in the wellbore where a measurement of fluid flow is to be obtained while the flow in the wellbore is shut off (typically by closing a choke valve or other valve stopping the flow at the surface). The downhole robot 102a clamps itself in place by deploying the anchoring system 700a. The fluid flow is started by opening a valve at the surface and the downhole robot 102a performs a flow measurement using the fluid flow sensor while being held in place against the flow by the anchoring system 700a. The flow is stopped (e.g., by again closing a valve at the surface), the downhole robot 102a retracts the anchoring system 700a and may travel to a new measurement location or return to the surface.

FIG. 7B is an illustration of the anchoring system of FIG. 7A in a partially expanded configuration 700b, according to an implementation of the present disclosure. As illustrated, the rotation of the rotor 706a to a second position 707b enables the movement of the rotor arms 708a and the hinged struts 702a to expand the anchoring system 700a outwardly.

FIG. 7C is an illustration of the anchoring system of FIG. 7A in a fully expanded configuration 700c, according to an implementation of the present disclosure. As shown in the figure, the final position of the rotor 706a to a third position 707c permits the anchoring system 700a to fully expand outwardly.

Non-contact Method to Enable and Disable Electrical Power of Untethered Logging Vehicles with a Sealed Volume

A method is described to enable/disable a power system of an untethered vehicle (e.g., a downhole robot 102a) without a need for opening the pressure housing 104a or external wired connections. Existing tethered logging systems typically have power supplied by the surface. Or, in case of battery powered tools (e.g., memory tools), have ample power available internally to the tool as they do not need to budget for excess weight or long duration autonomous missions. Untethered robotic/autonomous logging vehicles have tight design requirements on a amount of weight that can be added to the vehicle and the duration of missions that the vehicle may need to perform. As such, there is a limitation in the amount of weight available for power storage, and tight energy budgets that demand strict control over power consumption of the system before, during, and after a mission.

It is desirable to enable and disable a power system of the downhole robot 102a using non-contact methods (i.e., through the pressure housing 104a), such that the power system can be turned on and turned off without:
1) Unnecessary power consumption when the tool is not in use.
2) Opening the pressure housing 104a in order to turn on the power system.
3) Requiring wired connections outside of the pressure housing 104a that can create mechanical leak paths and electrical power leakage.

A method is provided using magnetic actuation of switches. In an implementation, a pair of magnetic reed switches are used, along with a microcontroller and transistor, to enable and disable the power system using a single magnet at a single location.

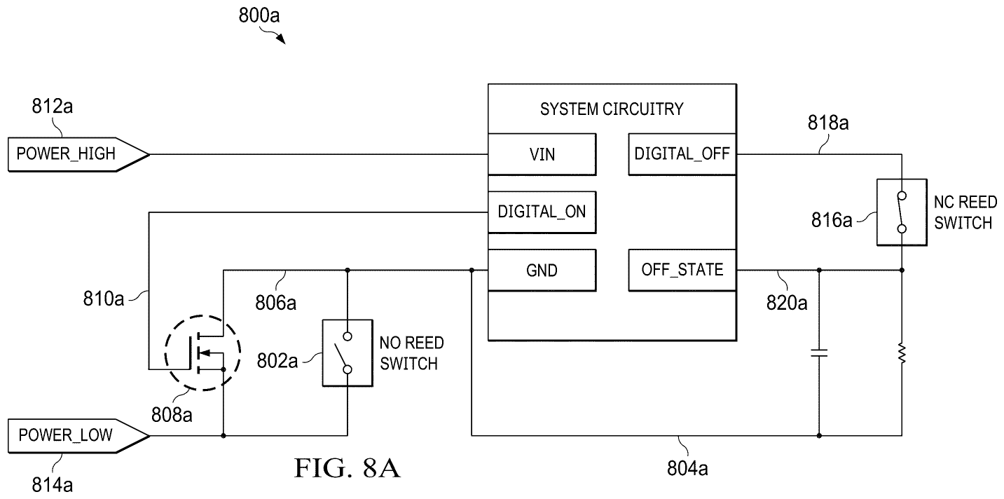

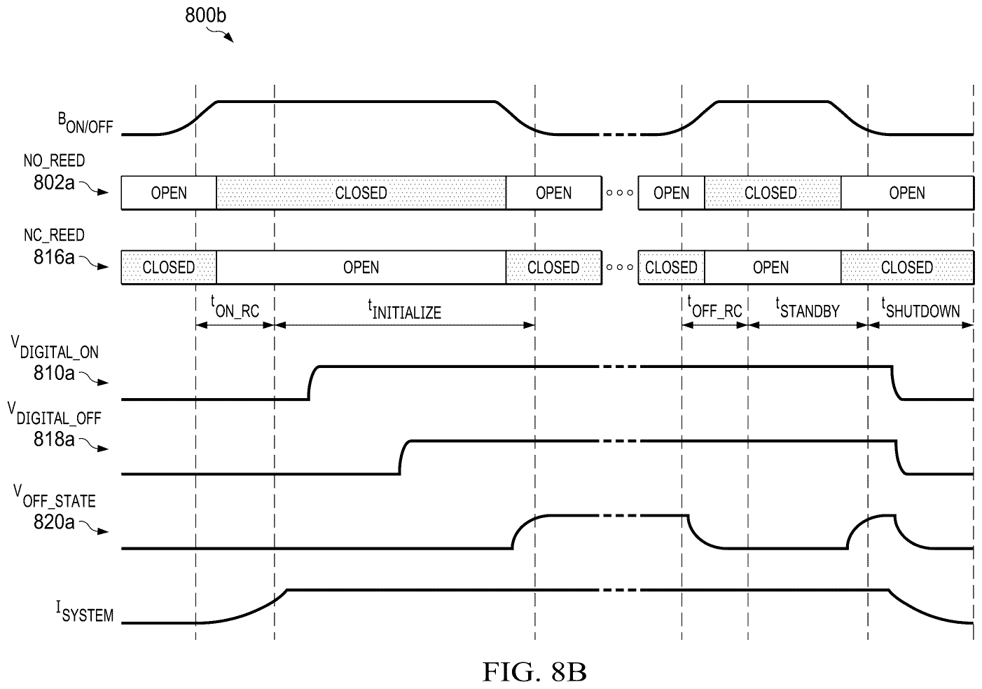

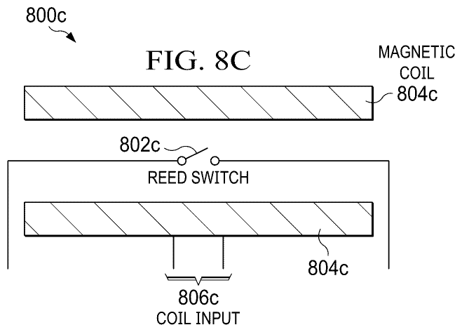

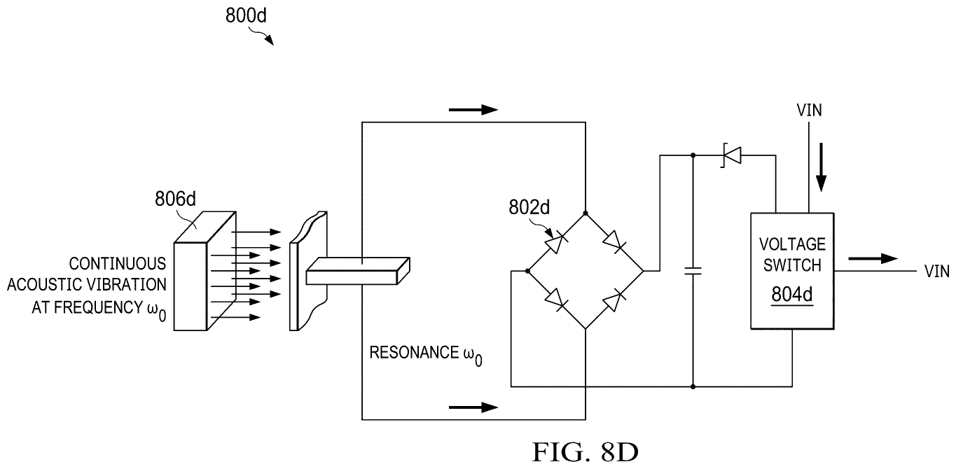

FIG. 8A is a schematic diagram illustrating an example power circuit 800a for permitting a non-contact method of operation of the downhole robot for oil wells, according to an implementation of the present disclosure.

In this implementation, a normally open reed switch 802a is located between the local ground 804a of the electronics system and the ground/return of the power supply 806a. An n-type transistor 808a is in parallel with the normally open reed switch, with a digital line 810a controlling its gate. When the power system is disabled, the normally open reed switch 802a is open and the transistor 808a is open, such that current cannot flow from POWER_HIGH 812a to POWER_LOW 814a. A small amount of current may leak through the transistor, but in typical N-type metal-oxide-semiconductor (NMOS) processes this is ≤1 uA. A normally closed reed switch 816a is connected to a digital line 818a that can be high or low, and the local ground 804a of the electronics system. An OFF_STATE line 820a permits a turn off process.

FIG. 8B is an illustration of an example timing diagram 800b of the power circuit of FIG. 8A, according to an implementation of the present disclosure.

In an implementation, a process for enabling and disabling the power system with the described implementation is:
1) Turn-on Process:
   a. User brings a magnet near the untethered downhole robot 102a.
   b. Normally open reed switch 802a closes, normally closed reed switch 816a opens. The off-state switch does not matter at this point in the process.
   c. Ground continuity occurs through normally open reed switch 802a, digital controller turns on.
   d. Digital controller holds [DIGITAL_ON] line 810a high to enable POWER_LOW 814a (low-side NMOS).
   e. Digital controller completes initialization process, including holding [DIGITAL_OFF] line 818a high.
   f. User moves magnet away from the untethered downhole robot 102a.
   g. Normally open reed switch 802a opens, normally closed reed switch 816a closes. [OFF_STATE] line 820a pulls high. Ground continuity maintained through POWER_LOW 814a (low-side NMOS), so the on-state reed switch 802a does not matter at this point in the process.
   h. Digital controller enables monitoring of turn-off process after [OFF_STATE] line 820a low/high transition.
2) Turn-off process:
   a. User brings magnet near the untethered downhole robot 102a.
   b. Normally open reed switch 802a closes, normally closed reed switch 816a opens. [OFF_STATE] line 820a pulls low. Ground continuity is still maintained through POWER_LOW 814 (low-side NMOS), so the on-state reed switch 802a does not matter at this point in the process.
   c. Digital controller flagged by [OFF_STATE] line 820a high/low transition.
   d. User moves magnet away from untethered downhole robot 102a.
   e. Normally open reed switch 802a opens, normally closed reed switch 816a closes. [OFF_STATE] line 820a pulls high. Ground continuity is still maintained through POWER_LOW 814a (low-side NMOS), so the on-state reed switch 802a does not matter at this point in the process.
   f. Digital controller is flagged by [OFF_STATE] low/high transition. Digital controller turns off [DIGITAL_ON] line, ground is disconnected, system is shut down.

In an implementation, multiple instances of the described circuit of FIG. 8A or multiple reed switches can be located at different positions of the untethered downhole robot 102 in order to enable and disable specific functions.

FIG. 8C is an illustration of an example induction-based reed switch 800c utilized in the example power circuit of FIG. 8A, according to an implementation of the present disclosure.

In an implementation, reed switches utilized may be polarized magnets, such that multiple functions can be enabled and disabled using a single reed switch 802c and a user-controlled magnet (e.g., the reed switch acting as a single pole double throw (SPDT) switch with control over which circuit is enabled based on the polarity of the magnet used for enabling and disabling).

In an implementation, the induction-based reed switches 802c are inserted inside a magnetic coil 804c powered by an electrical voltage 806c that can be generated through, for example, a magnetic, acoustic, photelectric, or thermoelectric energy harvester (refer to FIG. 8D).

To power on/off the reed switches in this implementation, the untethered downhole robot 102a needs to be close to an excitation source generating enough power to generate a magnetic field sufficient to trigger the reed switch.

FIG. 8D is an illustration of an example energy harvesting circuit 800d for power generation, according to an implementation of the present disclosure. The illustrated example energy harvesting circuit 800d, an acoustic method to harvest energy to power the magnetic coil 804c of the reed switch can be triggered through a piezoelectric energy transducer 802d.

In an implementation, the piezoelectric sensor is designed to have a frequency of ω0 with high quality factor able to generate enough voltage around its resonance frequency to trigger the voltage switch 804d. To drive this transducer, an acoustic excitation 806d with a frequency ω0 need to be generated. This excitation is coupled through the pressure housing 104a of the untethered downhole robot 102a to the piezoelectric transducer.

In this implementation, the electrical circuitry connected to the piezoelectric harvester 800d ensures the conversion of sinusoidal voltage with frequency ω0 to a DC voltage to trigger the voltage switch 804d while shielding any impulse or sudden noise generated from impact or other frequency excitations.

In some implementations, a piezoelectric-based voltage driven switch can be used instead of magnetic reed switch. In an implementation, multiple piezoelectric energy harvesters with different resonance frequencies can be used to enable multiple functions in the downhole robot 102b.

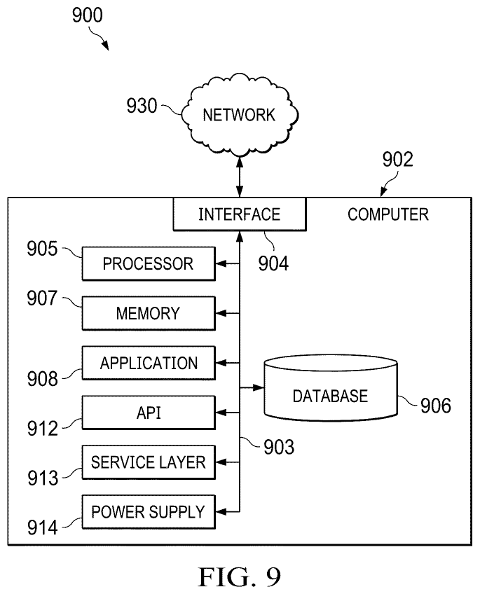

FIG. 9 is a block diagram illustrating an example of a computer-implemented System 900 used to provide computational functionalities associated with described algorithms, methods, functions, processes, flows, and procedures, according to an implementation of the present disclosure. In the illustrated implementation, computer-implemented system 900 includes a Computer 902 and a Network 930.

The illustrated Computer 902 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 902 can include an input device, such as a keypad, keyboard, or touch screen, or a combination of input devices that can accept user information, and an output device that conveys information associated with the operation of the Computer 902, including digital data, visual, audio, another type of information, or a combination of types of information, on a graphical-type user interface (UI) (or GUI) or other UI.

The Computer 902 can serve in a role in a distributed computing system as, for example, a client, network component, a server, or a database or another persistency, or a combination of roles for performing the subject matter described in the present disclosure. The illustrated Computer 902 is communicably coupled with a Network 930. In some implementations, one or more components of the Computer 902 can be configured to operate within an environment, or a combination of environments, including cloud-computing, local, or global.

At a high level, the Computer 902 is an electronic computing device operable to receive, transmit, process, store, or manage data and information associated with the described subject matter. According to some implementations, the Computer 902 can also include or be communicably coupled with a server, such as an application server, e-mail server, web server, caching server, or streaming data server, or a combination of servers.

The Computer 902 can receive requests over Network 930 (for example, from a client software application executing on another Computer 902) and respond to the received requests by processing the received requests using a software application or a combination of software applications. In addition, requests can also be sent to the Computer 902 from internal users (for example, from a command console or by another internal access method), external or third-parties, or other entities, individuals, systems, or computers.

Each of the components of the Computer 902 can communicate using a System Bus 903. In some implementations, any or all of the components of the Computer 902, including hardware, software, or a combination of hardware and software, can interface over the System Bus 903 using an application programming interface (API) 912, a Service Layer 913, or a combination of the API 912 and Service Layer 913. The API 912 can include specifications for routines, data structures, and object classes. The API 912 can be either computer-language independent or dependent and refer to a complete interface, a single function, or even a set of APIs. The Service Layer 913 provides software services to the Computer 902 or other components (whether illustrated or not) that are communicably coupled to the Computer 902. The functionality of the Computer 902 can be accessible for all service consumers using the Service Layer 913. Software services, such as those provided by the Service Layer 913, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 902, alternative implementations can illustrate the API 912 or the Service Layer 913 as stand-alone components in relation to other components of the Computer 902 or other components (whether illustrated or not) that are communicably coupled to the Computer 902. Moreover, any or all parts of the API 912 or the Service Layer 913 can be implemented as a child or a sub-module of another software module, enterprise application, or hardware module without departing from the scope of the present disclosure.

The Computer 902 includes an Interface 904. Although illustrated as a single Interface 904, two or more Interfaces 904 can be used according to particular needs, desires, or particular implementations of the Computer 902. The Interface 904 is used by the Computer 902 for communicating with another computing system (whether illustrated or not) that is communicatively linked to the Network 930 in a distributed environment. Generally, the Interface 904 is operable to communicate with the Network 930 and includes logic encoded in software, hardware, or a combination of software and hardware. More specifically, the Interface 904 can include software supporting one or more communication protocols associated with communications such that the Network 930 or hardware of Interface 904 is operable to communicate physical signals within and outside of the illustrated Computer 902.

The Computer 902 includes a Processor 905. Although illustrated as a single Processor 905, two or more Processors 905 can be used according to particular needs, desires, or particular implementations of the Computer 902. Generally, the Processor 905 executes instructions and manipulates data to perform the operations of the Computer 902 and any algorithms, methods, functions, processes, flows, and procedures as described in the present disclosure.

The Computer 902 also includes a Database 906 that can hold data for the Computer 902, another component communicatively linked to the Network 930 (whether illustrated or not), or a combination of the Computer 902 and another component. For example, Database 906 can be an in-memory or conventional database storing data consistent with the present disclosure. In some implementations, Database 906 can be a combination of two or more different database types (for example, a hybrid in-memory and conventional database) according to particular needs, desires, or particular implementations of the Computer 902 and the described functionality. Although illustrated as a single Database 906, two or more databases of similar or differing types can be used according to particular needs, desires, or particular implementations of the Computer 902 and the described functionality. While Database 906 is illustrated as an integral component of the Computer 902, in alternative implementations, Database 906 can be external to the Computer 902. The Database 906 can hold and operate on at least any data type mentioned or any data type consistent with this disclosure.

The Computer 902 also includes a Memory 907 that can hold data for the Computer 902, another component or components communicatively linked to the Network 930 (whether illustrated or not), or a combination of the Computer 902 and another component. Memory 907 can store any data consistent with the present disclosure. In some implementations, Memory 907 can be a combination of two or more different types of memory (for example, a combination of semiconductor and magnetic storage) according to particular needs, desires, or particular implementations of the Computer 902 and the described functionality. Although illustrated as a single Memory 907, two or more Memories 907 or similar or differing types can be used according to particular needs, desires, or particular implementations of the Computer 902 and the described functionality. While Memory 907 is illustrated as an integral component of the Computer 902, in alternative implementations, Memory 907 can be external to the Computer 902.

The Application 908 is an algorithmic software engine providing functionality according to particular needs, desires, or particular implementations of the Computer 902, particularly with respect to functionality described in the present disclosure. For example, Application 908 can serve as one or more components, modules, or applications. Further, although illustrated as a single Application 908, the Application 908 can be implemented as multiple Applications 908 on the Computer 902. In addition, although illustrated as integral to the Computer 902, in alternative implementations, the Application 908 can be external to the Computer 902.

The Computer 902 can also include a Power Supply 914. The Power Supply 914 can include a rechargeable or non-rechargeable battery that can be configured to be either user- or non-user-replaceable. In some implementations, the Power Supply 914 can include power-conversion or management circuits (including recharging, standby, or another power management functionality). In some implementations, the Power Supply 914 can include a power plug to allow the Computer 902 to be plugged into a wall socket or another power source to, for example, power the Computer 902 or recharge a rechargeable battery.

There can be any number of Computers 902 associated with, or external to, a computer system containing Computer 902, each Computer 902 communicating over Network 930. Further, the term “client,” “user,” or other appropriate terminology can be used interchangeably, as appropriate, without departing from the scope of the present disclosure. Moreover, the present disclosure contemplates that many users can use one Computer 902, or that one user can use multiple computers 902.

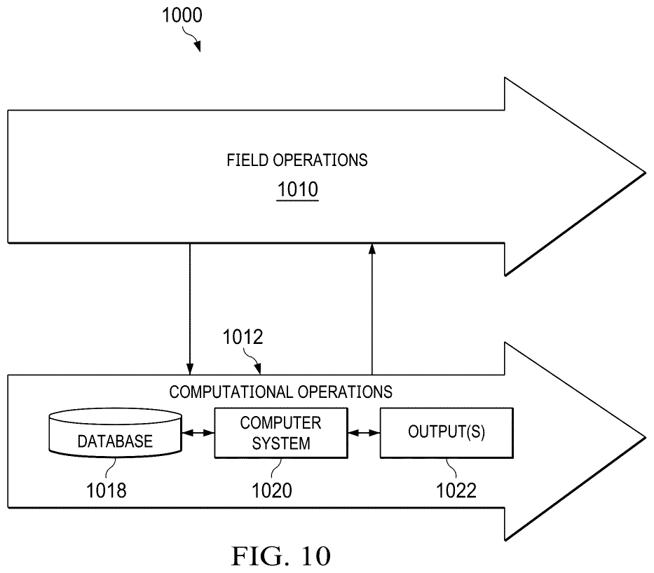

FIG. 10 illustrates hydrocarbon production operations 1000 that include both one or more field operations 1010 and one or more computational operations 1012, which exchange information and control exploration for the production of hydrocarbons. In some implementations, outputs of techniques of the present disclosure can be performed before, during, or in combination with the hydrocarbon production operations 1000, specifically, for example, either as field operations 1010 or computational operations 1012, or both.

Examples of field operations 1010 include forming/drilling a wellbore, hydraulic fracturing, producing through the wellbore, injecting fluids (such as water) through the wellbore, to name a few. In some implementations, methods of the present disclosure can trigger or control the field operations 1010. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1010 and responsively triggering the field operations 1010 including, for example, generating plans and signals that provide feedback to and control physical components of the field operations 1010. Alternatively, or in addition to, the field operations 1010 can trigger the methods of the present disclosure. For example, implementing physical components (including, for example, hardware, such as sensors) deployed in the field operations 1010 can generate plans and signals that can be provided as input or feedback (or both) to the methods of the present disclosure.

Examples of computational operations 1012 include one or more computer systems 1020 that include one or more processors and computer-readable media (e.g., non-transitory computer-readable media) operatively coupled to the one or more processors to execute computer operations to perform the methods of the present disclosure. The computational operations 1012 can be implemented using one or more databases 1018, which store data received from the field operations 1010 and/or generated internally within the computational operations 1012 (e.g., by implementing the methods of the present disclosure) or both. For example, the one or more computer systems 1020 process inputs from the field operations 1010 to assess conditions in the physical world, the outputs of which are stored in the databases 1018. For example, seismic sensors of the field operations 1010 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1012 where they are stored in the databases 1018 and analyzed by the one or more computer systems 1020.

In some implementations, one or more outputs 1022 generated by the one or more computer systems 1020 can be provided as feedback/input to the field operations 1010 (either as direct input or stored in the databases 1018). The field operations 1010 can use the feedback/input to control physical components used to perform the field operations 1010 in the real world.

For example, the computational operations 1012 can process the seismic data to generate three-dimensional (3D) maps of the subsurface formation. The computational operations 1012 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1012 to process new information about the formation and control the drilling to adjust to the observed conditions in real-time.

The one or more computer systems 1020 can update the 3D maps of the subsurface formation as information from one exploration well is received and the computational operations 1012 can adjust the location of the next exploration well based on the updated 3D maps. Similarly, the data received from production operations can be used by the computational operations 1012 to control components of the production operations. For example, production well and pipeline data can be analyzed to predict slugging in pipelines leading to a refinery and the computational operations 1012 can control machine operated valves upstream of the refinery to reduce the likelihood of plant disruptions that run the risk of taking the plant offline.

In some implementations of the computational operations 1012, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

Described implementations of the subject matter can include one or more features, alone or in combination.

For example, in a first implementation, a downhole robot for oil wells, comprising: a pressure housing enclosing an internal gas-filled or vacuum-filled volume; at least one propulsion unit coupled to an end of the pressure housing; at least one centralization element; at least one sensor to measure properties of interest with respect to the downhole robot and for an environment outside of the downhole robot; a buoyancy system; an electrical power supply; an anchoring system; and a power system configured for non-contact operation.

The foregoing and other described implementations can each, optionally, include one or more of the following features:

A first feature, combinable with any of the following features, comprising a propulsion unit of the at least one propulsion unit coupled to each end of the pressure housing.

A second feature, combinable with any of the previous or following features, wherein the propulsion unit comprises counter-rotating, co-axial propellers.

A third feature, combinable with any of the previous or following features, wherein the at least one propulsion unit is configured to adjust blade pitch of a propeller, wherein blade pitch is increased in lighter density fluid and blade pitch is decreased in higher density fluid.

A fourth feature, combinable with any of the previous or following features, wherein the at least one propulsion unit is configured to adjust rotation speed of a propeller with constant blade pitch to keep an instantaneous mass flow rate identical past the propeller regardless of fluid density, and wherein the propeller rotates faster in lighter density fluid and higher density fluid.

A fifth feature, combinable with any of the previous or following features, wherein a propeller of the at least one propulsion unit comprises an odd number of symmetrically arranged blades, and wherein a rotation rate of the propeller of the at least one propulsion unit is varied over a course of each rotation.

A sixth feature, combinable with any of the previous or following features, wherein the at least one centralization element is coupled at each end of the pressure housing.

A seventh feature, combinable with any of the previous or following features, wherein the at least one centralization element is a spring, wire, skid, or post/nub.

An eighth feature, combinable with any of the previous or following features, wherein the at least one sensor comprises one or more sensors to measure: temperature, pressure, fluid flow rate, fluid composition, fluid density, fluid viscosity, pipe or wellbore diameter or geometry, corrosion, scale, sand deposit, casing collar detection, acoustic/acoustic sonar, vibration, accelerometer, gyroscope, magnetic fields, attitude, gravity, navigation, casing collar location, metal, optical images, electromagnetic images, and induction values.

A ninth feature, combinable with any of the previous or following features, wherein the buoyancy system comprises at least one of: detachable weights, buoyancy/active ballast tanks, a bladder filled with liquid, and electrolysis.

A tenth feature, combinable with any of the previous or following features, wherein the buoyancy system can be unidirectional or bidirectional.

An eleventh feature, combinable with any of the previous or following features, wherein the electrical power supply comprises one or more batteries.

A twelfth feature, combinable with any of the previous or following features, wherein the anchoring system comprises a Hoberman mechanism, stator, and rotor.

A thirteenth feature, combinable with any of the previous or following features, wherein the Hoberman mechanism expands or contracts based on rotation of the rotor.

A fourteenth feature, combinable with any of the previous or following features, wherein the anchoring system comprises a spring loaded mechanism to bias the anchoring system into a collapsed state.

A fifteenth feature, combinable with any of the previous or following features, wherein the anchoring system comprises an elastic shroud to produce a seal against a wellbore or production pipe.

A sixteenth feature, combinable with any of the previous or following features, wherein the elastic shroud prevents flow through an annulus between the downhole robot and the wellbore or production pipe.

A seventeenth feature, combinable with any of the previous or following features, wherein the power system comprises polarized magnets, wherein functions associated with the functions can be enabled and disabled based on polarity of a magnet used for enabling or disabling the power system.

An eighteenth feature, combinable with any of the previous or following features, wherein the power system comprises an induction-based reed switch inserted inside a magnetic coil powered by an electrical voltage, and wherein the electrical voltage is generated through a magnetic, acoustic, photoelectric, or thermoelectric energy harvester.

A nineteenth feature, combinable with any of the previous or following features, wherein the downhole robot is configured to be closely positioned to a voltage-inducing excitation source to trigger the induction-based reed switch.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near (ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), crasable programmable read-only memory (EPROM), electrically erasable programmable read-only memory (EEPROM), and flash memory devices; magnetic devices, for example, tapc, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A downhole robot for oil wells, comprising:
a pressure housing enclosing an internal gas-filled or vacuum-filled volume;
at least one propulsion unit coupled to an end of the pressure housing;
at least one centralization element;
at least one sensor to measure properties of interest with respect to the downhole robot and for an environment outside of the downhole robot;
a buoyancy system;
an electrical power supply;
an anchoring system; and
a power system configured for non-contact operation.

2. The downhole robot for oil wells of claim 1, comprising a propulsion unit of the at least one propulsion unit coupled to each end of the pressure housing.

3. The downhole robot for oil wells of claim 2, wherein the propulsion unit comprises counter-rotating, co-axial propellers.

4. The downhole robot for oil wells of claim 1, wherein the at least one propulsion unit is configured to adjust blade pitch of a propeller, wherein blade pitch is increased in lighter density fluid and blade pitch is decreased in higher density fluid.

5. The downhole robot for oil wells of claim 1, wherein the at least one propulsion unit is configured to adjust rotation speed of a propeller with constant blade pitch to keep an instantaneous mass flow rate identical past the propeller regardless of fluid density, and wherein the propeller rotates faster in lighter density fluid and higher density fluid.

6. The downhole robot for oil wells of claim 1, wherein a propeller of the at least one propulsion unit comprises an odd number of symmetrically arranged blades, and wherein a rotation rate of the propeller of the at least one propulsion unit is varied over a course of each rotation.

7. The downhole robot for oil wells of claim 1, wherein the at least one centralization element is coupled at each end of the pressure housing.

8. The downhole robot for oil wells of claim 1, wherein the at least one centralization element is a spring, wire, skid, or post/nub.

9. The downhole robot for oil wells of claim 1, wherein the at least one sensor comprises one or more sensors to measure: temperature, pressure, fluid flow rate, fluid composition, fluid density, fluid viscosity, pipe or wellbore diameter or geometry, corrosion, scale, sand deposit, casing collar detection, acoustic/acoustic sonar, vibration, accelerometer, gyroscope, magnetic fields, attitude, gravity, navigation, casing collar location, metal, optical images, electromagnetic images, and induction values.

10. The downhole robot for oil wells of claim 1, wherein the buoyancy system comprises at least one of: detachable weights, buoyancy/active ballast tanks, a bladder filled with liquid, and electrolysis.

11. The downhole robot for oil wells of claim 10, wherein the buoyancy system can be unidirectional or bidirectional.

12. The downhole robot for oil wells of claim 11, wherein the electrical power supply comprises one or more batteries.

13. The downhole robot for oil wells of claim 1, wherein the anchoring system comprises a Hoberman mechanism, stator, and rotor.

14. The downhole robot for oil wells of claim 13, wherein the Hoberman mechanism expands or contracts based on rotation of the rotor.

15. The downhole robot for oil wells of claim 13, wherein the anchoring system comprises a spring loaded mechanism to bias the anchoring system into a collapsed state.

16. The downhole robot for oil wells of claim 13, wherein the anchoring system comprises an elastic shroud to produce a seal against a wellbore or production pipe.

17. The downhole robot for oil wells of claim 16, wherein the elastic shroud prevents flow through an annulus between the downhole robot and the wellbore or production pipe.

18. The downhole robot for oil wells of claim 1, wherein the power system comprises polarized magnets, wherein functions associated with the functions can be enabled and disabled based on polarity of a magnet used for enabling or disabling the power system.

19. The downhole robot for oil wells of claim 1, wherein the power system comprises an induction-based reed switch inserted inside a magnetic coil powered by an electrical voltage, and wherein the electrical voltage is generated through a magnetic, acoustic, photoelectric, or thermoelectric energy harvester.

20. The downhole robot for oil wells of claim 19, wherein the downhole robot is configured to be closely positioned to a voltage-inducing excitation source to trigger the induction-based reed switch.
